(19) United States
(12) Patent Application Publication
(10) Pub. No.: US 2012/0303976 A1
(43) Pub. Date: Nov. 29, 2012

(54) DATA STORAGE APPARATUS

(75) Inventor: CHIH-WEI HO, NEW TAIPEI CITY (TW)

(73) Assignee: ATP ELECTRONICS TAIWAN INC., TAIPEI (TW)

(21) Appl. No.: 13/166,890

(22) Filed: Jun. 23, 2011

(30) Foreign Application Priority Data
May 25, 2011 (TW) 100209353

(51) Int. Cl. G06F 1/26

(52) U.S. Cl. 713/300

(57) ABSTRACT

A data storage apparatus includes a storage unit; a read/write console connected electrically to an external power supply source; a storage function unit; a power switch connected electrically to the power supply source, the storage unit and the storage function unit in such a manner that in a normal condition, the storage unit is charged electrically by the power supply source via the power switch, and that in an abnormal condition, the storage unit is supplied with electrical power from the power switch via the storage function unit so as to permit continuation of the read/write operation within the storage unit. A current detection unit detects current of the storage function unit in the abnormal condition and upon detecting current of the storage function unit reaching below a predetermined threshold value, the current detection unit generates and transmits a reset signal to the read/write console such that the read/write console orders a reset of the read/write operation.

This application claims the benefits of the Taiwan Patent Application Serial No. 100209353 filed on May 25, 2011, the subject matter of which is incorporated herein by reference.

### BACKGROUND OF THE INVENTION

1. Field of the Invention

The present invention relates to a data storage apparatus, more particularly to a data storage apparatus, which has a compact size and which can prevent loss of data therefrom in case the same is disconnected electrically from a power supply source.

2. Description of the Prior Art

Due to rapid advance in the electronic technology, electronic devices are generally implemented in our daily life and working environments. A data storage apparatus, such as a memory card or stick, is applied in a PC (personal computer), a camera and a smart phone, and hence it becomes an indispensible item for the camera, smart phone or the PC.

During the storing process of data into the data storage apparatus with the use of PC, the most unwelcome event is that an un-finished document temporarily stored within the storage apparatus may get lost or disappear due to the reason that the PC or the device is disconnected electrically from an external power supply source.

In the prior art, a large capacitor can be mounted and is electrically connected to a storage unit and a micro control unit in order to prevent loss of data since the large capacitor can supply power to the storage unit and the micro control unit in case of electrical disconnection, thereby permitting completion of the presently read/write operation.

As mentioned above, since the large capacitor is required to simultaneously supply electrical power to the storage unit and the micro control unit, the capacitor itself must possess a relatively large size. Hence, the trench toward the production of the electronic devices in compact size is hard to achieve.

### SUMMARY OF THE INVENTION

Therefore, the object of the present invention is to provide a data storage apparatus, which has a compact size and which can prevent loss of data therefrom in case the same is disconnected electrically from a power supply source.

A data storage apparatus according to the present invention includes a storage unit; a read/write console connected electrically to an external power supply source; a storage function unit; a power switch connected electrically to the power supply source, the storage unit and the storage function unit in such a manner that in a normal condition, the storage unit is charged electrically by the power supply source via the power switch, and that in an abnormal condition, the storage unit is supplied with electrical power from the power switch via the storage function unit so as to permit continuation of the read/write operation within the storage unit. The data storage apparatus further includes a current detection unit for detecting current of the storage function unit in the abnormal condition and upon detecting current of the storage function unit reaching below a predetermined threshold value, the current detection unit generates and transmits a reset signal to the read/write console such that the read/write console orders a reset of the read/write operation.

In one embodiment of the present invention, the storage unit is selected from a group consisting of a Flash Memory, a RAM (Random Access Memory) and a DRAM (Dynamic Random Access Memory).

In one embodiment of the present invention, the read/write console is selected from a group consisting of a MCU (Micro Control Unit) and CPU (Central Processing Unit).

In one embodiment of the present invention, the storage function unit is a capacitor.

The data storage apparatus of the present invention further includes a power converter such that the external power supply source is electrically connected to the read/write console and the power switch via the power converter.

When compared to the prior art ones, in the data storage apparatus of the present invention, the storage function unit is required to supply electrical power to the storage unit only when the apparatus is disconnected electrically from an external power supply source so that the dimension of the storage function unit can be minimized. Hence the trench toward the production of the electronic device in compact size can be achieved.

### BRIEF DESCRIPTION OF THE DRAWINGS

Other features and advantages of this invention will become more apparent in the following detailed description of the preferred embodiment of this invention, with reference to the accompanying drawings, in which:

FIG. 1 shows a block diagram of a data storage apparatus of the present invention connected electrically to an external power supply source in a normal condition; and

FIG. 2 shows a block diagram of the data storage apparatus of the present invention connected electrically to the external power supply source in an abnormal condition.

### DETAILED DESCRIPTION OF THE PREFERRED EMBODIMENT

The feature of the present invention resides in a data storage apparatus, more particularly to a data storage apparatus, which has a compact size and which can prevent loss of data therefrom in case the same is disconnected electrically from an external power supply source. For better understanding of the present invention, a preferred embodiment is illustrated in the following paragraphs; however, the scope of the invention should not be limited only thereto.

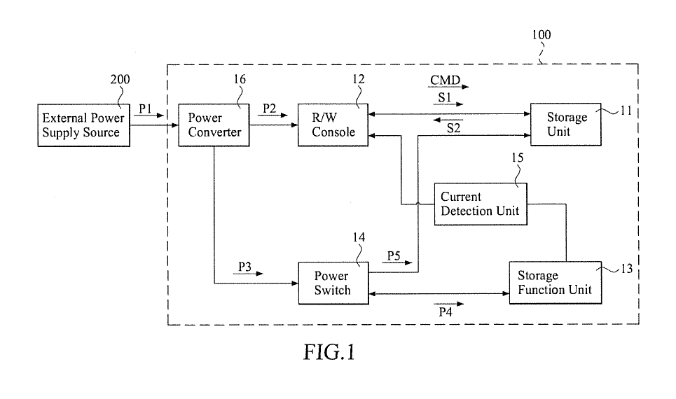

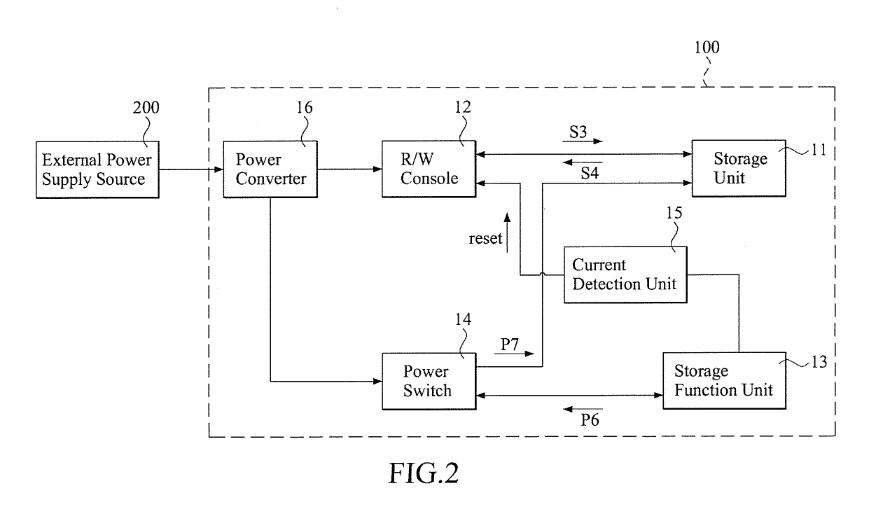

Referring to FIGS. 1 and 2, wherein FIG. 1 shows a block diagram of a data storage apparatus of the present invention connected electrically to an external power supply source in a normal condition while FIG. 2 shows a block diagram of the data storage apparatus of the present invention connected electrically to the external power supply source in an abnormal condition. As illustrated, the data storage apparatus 100 of the present invention accordingly includes a storage unit 11, a read/write console 12, a storage function unit 13, a power switch 14 and a current detection unit 15. In one embodiment of the present invention, the storage function unit 13 is a capacitor. In another embodiment, the storage unit 11 is selected from a group consisting of a Flash Memory, a RAM (Random Access Memory) and a DRAM (Dynamic Random Access Memory).

The read/write console 12 is connected electrically to an external power supply source 200 in order to receive the electrical power P2 for controlling a read/write operation of the storage unit 11. The read/write operation includes transmission of a read/write command CMD from the read /write console 12 to the storage unit 11 so that the data S1 is transmitted to the storage unit 11 or the read/write console 12 receives the data S2 from the storage unit 11. In one embodiment of the present invention, the read/write console 12 is selected from a group consisting of a MCU (Micro Control Unit) and a CPU (Central Processing Unit).

The power switch 14 is connected electrically to the external power supply source 200, the storage unit 11 and the storage function unit 13 in such a manner that when the external power source 200 is in a normal condition (i.e., supplying the electrical power), the power switch 14 receives the electrical power P3 from the external power supply source 200 and the storage function unit 13 is charged electrically by the electrical power P4 and simultaneously supply the electrical power P5 to the storage unit 11. In one embodiment of the present invention, the data storage apparatus 100 further includes a power converter 16 such that the external power supply source 200 is electrically connected to the read/write console 12 and the power switch 14 via the power converter 16 so that the electrical power P1 is converted by the power converter 16 into the electrical powers P2, P3 with required voltages which are compatible respectively with the read/write console 12 and the power switch 14.

When the external power supply source 200 is in an abnormal condition (i.e., supplying of the electrical power is disconnected), the power switch 14 receives the electrical power P6 from the storage function unit 13 and in turn supplies the electrical power P7 to the storage unit 11 so as to permit continuation of the read/write operation within the storage unit 11. Continuation of the read/write operation includes the storage unit 11 receives the reception data S3 from the read/write console 12 or the transmission data S4 is transmitted to the read/write console 12.

The current detection unit 15 is connected electrically to the storage function unit 13 for detecting current of the storage function unit 13 when the external power supply source 200 is in the abnormal condition. Upon detecting current of the storage function unit 13 reaches below a predetermined threshold value, the current detection unit 15 generates and transmits a reset signal to the read/write console 1 such that the read/write console 12 orders a reset of the read/write operation within the storage unit 11.

When compared to the prior art ones, in the data storage apparatus 100 of the present invention, the storage function unit 13 is required to supply electrical power to the storage unit 11 only when the apparatus 100 is disconnected electrically from the external power supply source 200 in order to maintain the normal operation of the storage unit 11 and the read/write console 12, while transmission of the reset signal due to reaching below the predetermined threshold vale of the storage function unit 13 is conducted by the current detection unit 15 so that the dimension of the storage function unit 13 can be minimized. Hence the trench toward the production of the data storage apparatus 100 of the present invention into compact size can be achieved.

While the invention has been described in connection with what is considered the most practical and preferred embodiments, it is understood that this invention is not limited to the disclosed embodiments but is intended to cover various arrangements included within the spirit and scope of the broadest interpretation so as to encompass all such modifications and equivalent arrangements.

What is claimed is:

1. A data storage apparatus comprising:
a storage unit;
a read/write console connected electrically to an external power supply source for controlling a read/write operation of said storage unit;
a storage function unit;
a power switch connected electrically to said external power supply source, said storage unit and said storage function unit in such a manner that when said external power source is in a normal condition, said storage unit is charged electrically by said external power supply source via said power switch, and that when said external power supply source is in an abnormal condition, said storage unit is supplied with electrical power from said power switch via said storage function unit so as to permit continuation of said read/write operation within said storage unit; and
a current detection unit connected electrically to said storage function unit for detecting current of said storage function unit when said external power supply source is in said abnormal condition, upon detecting current of said storage function unit reaching below a predetermined threshold value, said current detection unit generates and transmits a reset signal to said read/write console such that said read/write console orders a reset of said read/write operation within said storage unit.

2. The data storage apparatus according to claim 1, wherein said storage unit is selected from a group consisting of a Flash Memory, a RAM (Random Access Memory) and a DRAM (Dynamic Random Access Memory).

3. The data storage apparatus according to claim 1, wherein said read/write console is selected from a group consisting of a MCU (Micro Control Unit) and CPU (Central Processing Unit).

4. The data storage apparatus according to claim 1, wherein said storage function unit is a capacitor.

5. The data storage apparatus according to claim 1, further comprising a power converter such that said external power supply source is electrically connected to said read/write console and said power switch via said power converter.
